(19) United States
(12) Patent Application Publication
(10) Pub. No.: US 2013/0054307 A1
(43) Pub. Date: Feb. 28, 2013

(54) Labor and Materials Purchasing System for the Construction Industry

(71) Applicant: Brian Anthony Anson, Weddington, NC (US)

(72) Inventor: Brian Anthony Anson, Weddington, NC (US)

(73) Assignee: Daphoria, Inc., Weddington, NC (US)

(21) Appl. No.: 13/592,483

(22) Filed: Aug. 23, 2012

Related U.S. Application Data
(60) Provisional application No. 61/527,842, filed on Aug. 26, 2011.

(51) Int. Cl. G06Q 10/06; G06Q 30/02; G06Q 30/00

(52) U.S. Cl. 705/7.31; 705/26.4; 705/7.29

(57) ABSTRACT

A system for managing labor and materials on a construction site includes a database stored on a computer-readable storage medium, a field-application module in communication with the database, and a vendor module in communication with the database. The field-application module receives information related to materials, labor, and/or services from a data-entry device and stores the information in the database. The vendor module receives vendor information and stores the information in the database. When the field-application module receives a bid request from the data-entry device, the vendor module transmits the bid request to a plurality of vendors. Next, when the vendor module receives bids from one or more vendors, the field-application module transmits one or more of the bids to the data-entry device. Finally, when the field-application module receives a purchase order from the data-entry device, the vendor module transmits the purchase order to the relevant vendor.

### REFERENCE TO PRIORITY APPLICATION

This U.S. nonprovisional application claims the benefit of U.S. Patent Application Ser. No. 61/527,842 for a Labor and Materials Purchasing System for the Construction Industry (filed Aug. 26, 2011), which is hereby incorporated by reference in its entirety.

### FIELD OF INVENTION

The present invention relates to a computerized system for tracking and purchasing labor and materials for the construction industry along with a method of analyzing pricing data on a real-time basis to predict future costs for construction projects.

### BACKGROUND

The construction sector has experienced a long felt need for automating the delivery, use, tracking, and purchasing of labor and materials on a construction site. Construction management has traditionally included a laborious administrative process in which teams overseeing the physical work on the construction site provide reports to management personnel in remote offices. The reports indicate the kinds of labor and material on hand at the site as well as those that need to be replenished. Managing personnel then arrange for procurement of needed items and manpower. Obviously, this arrangement takes time and adds to the overhead necessary in the project.

In a traditional system, procurement managers issue requests for proposals or invitations to bid so that suppliers and subcontractors can vie for the chance to complete a contract for labor and materials delivery. The process has been automated with the advent of web-based systems and email, but the overwhelming inefficiency of information delivery remains inherent in many construction sites because the individuals closest to the need (e.g., foremen and team leaders using the actual labor and materials) are separated from the procurement process.

Development efforts in the field of automated procurement systems have predominantly focused on the relationship between procurement personnel in a construction company and vendors who wish to bid, as opposed to including the construction team who actually uses the materials and labor on the site. For example, U.S. Pat. No. 7,881,977, which is hereby incorporated by reference in its entirety, shows a construction bidding system and method that includes a manager, a general contractor, and a subcontractor having workstations that communicate with a server hosting a website over a network. The manager is allowed to select general contractors from a database. The general contractor then selects subcontractors who are allowed to bid, after which the general contractor submits an overall bid to the construction manager. The system allows for consolidation of subcontractor pricing on labor and materials in a standardized format, and the data can be analyzed to view pricing trends. The system, however, cannot avoid the standard administrative procedure where construction teams on site and in the field must submit reports to a procurement manager, who eventually communicates with a supplier.

Other systems provide even more general access to data without streamlining construction procurement. U.S. Patent Application Publication No. 2010/0161495, which is hereby incorporated by reference in its entirety, shows a system and method for managing construction projects and/or pricing data. The system allows managers seeking to issue invitations for bids to search subcontractor and general contractor databases to select bidders. Likewise, contractors search the database to learn the details of upcoming construction projects.

U.S. Patent Application Publication No. 2006/0010005, which is hereby incorporated by reference in its entirety, shows yet another database approach to construction management that allows a user to search for each component necessary to engage in a construction project. The database incorporates modules so that the user may search for land, money, products, labor, and even purchasers who would want to own the finished project. This publication relies upon the concept that one integrated system with five core areas for searching can tie into one central hub and provide a virtual construction management team online. In one embodiment, the data stored in the central hub allows developers to look at historical numbers for certain kinds of construction projects and the materials that went into them. The developer can then fix the price of a prospective project by contracting for materials with certain suppliers at certain times. This system allows for supplier price consolidation into one location and provides some avenues for a developer to project future costs at a later point in time.

None of the prior systems noted above address the fact that the individuals most qualified for timely decision-making in construction projects are on site and using the labor and materials in real time. All of the systems known to date rely upon an office procurement manager to purchase items or schedule labor after being informed via a report issued by those in the field.

In regard to labor, tracking and ordering manpower on a construction site is a further area that is ripe for improvement. One known system of labor tracking is set forth in U.S. Patent Application Publication No. 2006/0193262, which is hereby incorporated by reference in its entirety. This publication notes that wireless sensory devices may be used in conjunction with workers' badges to automatically log the presence of the worker into the construction system. In this way, an automated system accounts for the labor force necessary to complete a particular kind of project.

Another issue in construction management lies in the tracking of incomplete installations, or punch lists. Most construction projects maintain issues lists that allow project managers to order the appropriate labor and materials to complete a project according to known standards. While the systems noted above allow for tracking and purchasing labor and materials via online systems, none of them account for activities that are occurring in real time at the construction site. One item in the prior art, namely International Patent Publication No. WO 2006102277, which is hereby incorporated by reference in its entirety, shows a system for attaching radio frequency tags to areas under construction so that workers can readily locate the site of unfinished work. In preparing an issues list for submission to management, a site foreman would attach the RF tag to a physical item on the site and then request that the administrative office purchase the labor and materials needed to complete the construction. While this method notes the usefulness of having some communications directly at the site of the unfinished work, it cannot alleviate the burden of proceeding with procurement through an administrative office.

Therefore, a need continues to exist in the construction sector for a system of procuring labor and materials that originates as close as possible to the point of use on the construction site and without the necessity of using a circuitous administrative process removed from the construction site itself.

### SUMMARY

In one aspect, the present invention embraces a system for managing labor and materials on a construction site.

The system includes a non-transitory computer-readable storage medium and a processor for manipulating the computer-readable storage medium. The system typically includes a database stored on the computer-readable storage medium, a field-application module in communication with the database, and a vendor module in communication with the database. The field-application module typically receives information related to materials, labor and/or services from a data-entry device, typically a portable data-entry device located on a construction site, and stores the information in the database. The vendor module typically receives vendor information and stores the information in the database. In operation, when the field-application module receives a bid request (e.g., a bid request for materials, labor, and/or services) from the data-entry device, the vendor module typically transmits (e.g., automatically transmits) the bid request to a plurality of vendors that are in communication with the vendor module. Next, when the vendor module receives bids from one or more vendors, the field-application module typically transmits (e.g., automatically transmits) one or more of the bids to the data-entry device. Finally, when the field-application module receives a purchase order from the data-entry device, the vendor module typically transmits (e.g., automatically transmits) the purchase order to the relevant vendor (i.e., the vendor whose bid has been accepted by the user of the data-entry device).

The foregoing illustrative summary, as well as other exemplary objectives and/or advantages of the invention, and the manner in which the same are accomplished, are further explained within the following detailed description and its accompanying drawing.

### BRIEF DESCRIPTION OF THE DRAWING

FIG. 1 schematically depicts a labor and materials purchasing system in accordance with the present invention.

### DETAILED DESCRIPTION

The system described herein provides a more efficient avenue for construction procurement that originates at a point of use on the construction site. For purposes herein, a point of use is one of many places physically located within a construction site. Without limiting the invention to any one embodiment, a point of use for labor and materials would be accessible by individuals physically located in areas where construction work is occurring. In one non-limiting embodiment, a point of use would be a place within the construction site where a foreman or construction manager oversees workers outside in the field. A point of use for labor and materials is distinguished for purposes herein from administrative offices or trailers on the construction site where employees enter data inside an office structure. The system of this invention allows for a worker, typically a field manager or foreman, to finalize a purchase order for labor and materials from any number of points of use on a construction site.

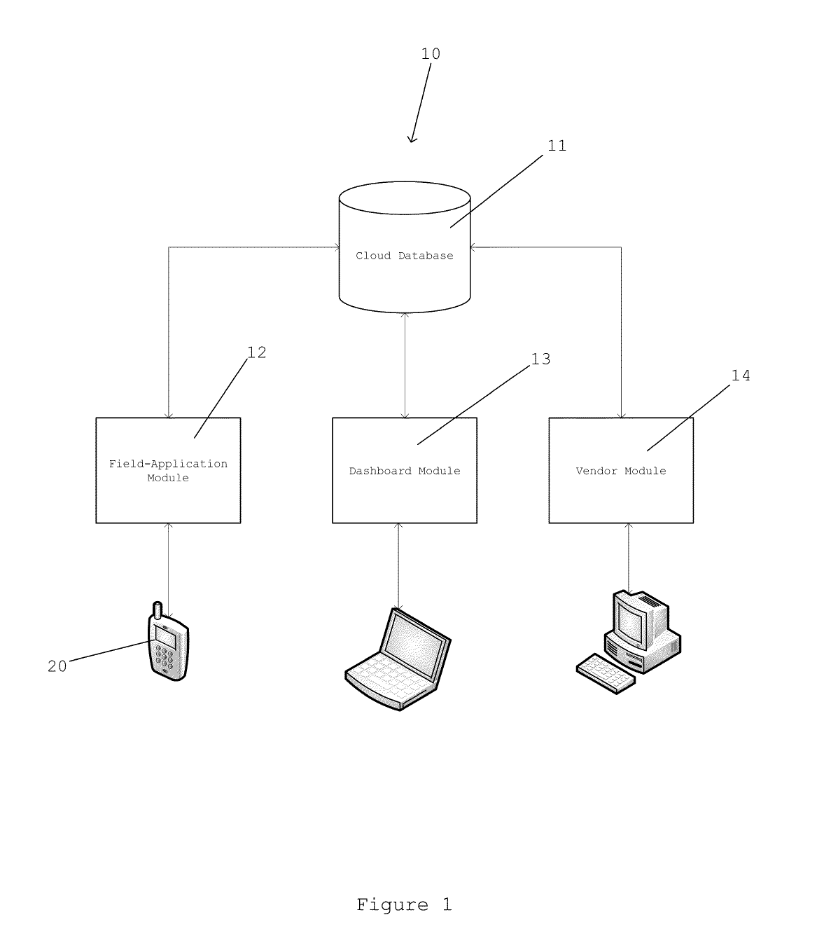

FIG. 1 depicts a labor and materials purchasing system 10 in accordance with the present invention. The purchasing system 10 typically includes a cloud database 11 in communication with a field-application module 12, a dashboard module 13, and a vendor module 14.

In this regard, the purchasing system 10 includes computer-readable storage medium (e.g., non-transitory computer-readable storage medium) for storing data (e.g., data in the database) and commands (e.g., commands relating to the field-application module 12, the dashboard module 13, and the vendor module 14). The purchasing system also includes a processor for executing commands and manipulating data stored on the computer-readable storage medium. The computer-readable storage medium and the processor may be located within one or more servers.

The cloud database 11 stores information received from the field-application module 12, the dashboard module 13, and from the vendor module 14.

The field-application module 12 typically includes a labor module, a materials module, a tasks module, an issues module, a notes module, a purchasing module, and an applications module. The field-application module 12 stores the information (e.g., information relating to labor and/or materials) received by these modules in the cloud database.

The labor module allows a user to enter information related to labor in order to log and track labor on a construction site. In this regard, with the labor module a user typically may add new workers to a project (e.g., a construction project), assign a worker to a task (e.g., a specific task within a construction project), and record a worker's time on a particular project and/or task. Furthermore, a user may assign a note or an issue to a worker. In one embodiment, the labor module may be used to track the presence of workers at a construction site (e.g., by a user entering the time when a worker has arrived at and departed from the construction site). A unique identifier (e.g., an identifying number or code) may be associated with each worker and stored in the database module. Accordingly, a user may add a new worker, record a worker's time, or assign a task to a worker by entering the relevant worker's identifier into the field-application module. Alternatively, it is within the scope of the present invention for the labor module to employ imaging software that detects changes in the status of labor via artificial intelligence directed to visual inspection.

The materials module allows a user to enter information related to materials in order to log and track materials on a construction site. As used herein, the term “materials” refers to raw materials, parts, and supplies used during construction and to equipment (e.g., tools) used during construction. The materials modules typically allows a user to add new materials to a project, record information relating to a particular material (e.g., amount, storage location on the construction site, and material safety data sheets), assign a note to a particular material, and record the usage of a certain amount of a particular material on a project and/or task. With the entered new materials information and the recorded usage of materials, the materials module may provide users with an inventory of on-site materials. A unique identifier (e.g., an identifying number or code) may be associated with each material and stored in the database module. Accordingly, a user may add new materials and record the usage of materials by entering the relevant material's identifier into the field-application module. Alternatively, it is within the scope of the present invention for the materials module to employ imaging software that detects changes in the status of materials via artificial intelligence directed to visual inspection.

The tasks module typically allows a user to add new tasks to a project, assign a task to a worker, record the progress of particular task (e.g., as a percentage completed), assign an issue to a task, and to assign a note to a task. A user may use the tasks module to view which tasks are assigned to a particular work. Accordingly, a worker could use the tasks module to view their assigned tasks.

The issues module typically allows a user to record issues related to a particular project, such as a disagreement between two contractors and safety issues that occur or may need to be corrected. With the issues module, a user may enter a request for information (e.g., related to field conditions or drawing details). Once a request for information has been entered, the issues module may automatically send the request for information (e.g., via email) to the appropriate party. In a particular embodiment, the issues module enables users to enter private information (e.g., a to-do list) that can only be seen by a specific user.

The notes module typically enables users to record notes related to workers, companies, materials, and issues. The notes module also typically enables users to record private notes. Notes may be recorded in the form of text, voice recordings, and/or video recordings. In one embodiment, the notes module may send a recorded note (e.g., via email) to an appropriate party.

The purchasing module typically enables users to input materials and/or labor that need to be purchased (e.g., in the form of a bid request). In addition to bid requests for materials and labor, it is within the scope of the present invention for users to submit bid requests for services (e.g., waste-removal services) through the purchasing module.

Once a bid request has been entered, the purchasing module forwards the bid request to the vendor module, which forwards the bid request to one or more vendors. Once bids have been made, the purchasing module receives the bids from the vendor module so the bids can be transmitted to and reviewed by the user. In a particular embodiment, the purchasing module transmits a limited number (e.g., three) of the most cost-effective bids to the user. Subsequently, the user may accept one of the bids.

Once a bid has been accepted, typically by receiving a purchase order from the user, the purchase order is sent, typically via the vendor module, to the relevant vendor. Once a purchase order has been received (e.g., by the purchasing module), the purchasing system typically creates a unique identifier (e.g., a unique barcode) associated with that purchase order. Furthermore, once the purchasing module receives the purchase order, the purchasing system typically withdraws funds for the purchase-order amount from an account (e.g., a credit card account, bank account, or PayPal™ account) associated with the user (e.g., associated with the user's company). These funds are typically held by the purchasing system until delivery has been confirmed. In this regard, the purchasing module typically provides tracking information related to a purchase to a user. Once materials, labor, and/or services have been delivered, a user may use the purchasing module to transmit a delivery confirmation to the purchasing system (e.g., by entering the unique identifier associated with the purchase order, such as by scanning a unique barcode). The unique identifier may also be entered into the labor module or the materials module to update information related to labor and/or materials (e.g., the quantity of a material onsite). In addition, the purchasing module typically enables users to view their purchase history.

The applications module typically enables users to post comments, suggestions, or bugs regarding the purchasing system. The applications module typically includes an applications store in which tools for customizing the field-application module may be purchased.

To achieve user access to the field-application module 12 at a point of use on the construction site, the purchasing system 10 is typically in communication with one or more data-entry devices 20 (e.g., a wireless data-entry device) over a network (e.g., the Internet). In other words, the data-entry device utilized at a point of use for labor and materials in a construction site typically communicates with the purchasing system via a cloud architecture. The term “cloud architecture” as used herein is used in its broadest senses to identify the kinds of networking and computing that allow on-demand access to shared computer and computerized memory resources. In one embodiment, the cloud is analogous to the Internet but encompasses remote devices sharing storage capacity from a single location other than the hardware on the remote device. By allowing a wireless data-entry device to utilize cloud-architecture communication protocols, the data-entry device has the capability of tapping into resources that are housed remotely but entirely functional from a point of use on the construction site. In this regard, although commands (e.g., in the form of software) related to the field-application module are typically stored on one or more servers in communication with the data-entry device, it is within the scope of the present invention to store commands related to the field-application module on one or more data-entry devices (e.g., on non-transitory computer-readable storage medium within a data-entry device).

The data-entry device 20 may be any computing device that is portable from one place to another within a construction site and capable of communicating over a network (e.g., the Internet) to other devices outside the construction site. Accordingly, the data-entry device 20 may be a cellular telephone, a satellite telephone, or a portable computer, such as a tablet computer (e.g., an i-Pad®). In one embodiment, the data-entry device 20 may communicate with the purchasing system 10 via a web server. To facilitate use of the field-application module 12, the purchasing system 10 may provide the data-entry device 20 with a graphical user interface (GUI). Aspects of an exemplary GUI are depicted in the appendix of priority U.S. Patent Application Ser. No. 61/527,842, which, as noted, is incorporated by reference in its entirety.

Because the data-entry device is typically portable throughout the construction site, the data-entry device enables a user located at any point of use in the construction site to initiate and finalize purchase orders for materials, labor, and/or services. What is more, the data-entry device enables a user to assess what labor and materials are currently in stock and currently needed at any place on the construction site.

As noted above, each worker and material typically has an associated unique identifier. In a particular embodiment, one or more of the unique identifiers may be barcodes. Therefore, the data-entry device may include a barcode scanner that accepts data by utilizing photo sensors incorporated into the data-entry device. As such, each material may be labeled with a unique barcode. In addition, each worker may have a unique barcode, which may appear on a badge or other identifying equipment. Using barcodes allows the user of the data-entry device to maintain an accurate check of the materials that have been delivered and used at the construction site, the workers that have arrived and departed from the construction site, and the current state of inventory available to complete the construction project.

A user of this system may incorporate the data-entry device into his or her daily routine of checking numerous areas in a single construction site. While checking on the progress of a certain part of the construction, the user will have the opportunity to scan materials housed at that location (i.e., that point of use). By scanning the materials, the purchasing system described herein allows the user to check how much of a certain material has been used, how much is on hand, and how much should be ordered, if any.

One aspect of the purchasing system of this invention is its ability to allow a user of the data-entry device to finalize a procurement right at the point of use for the material or labor being ordered. Therefore, the present purchasing system allows information (e.g., bid requests and purchase orders) to be delivered more quickly and directly to vendors providing labor or materials. From one point of use on a construction site, a user (e.g., a foreman or construction manager) can identify a need for labor or materials and finalize the purchase for delivery without going through a detailed administrative process through an administrative office or procurement manager.

The dashboard module 13 typically enables users (e.g., management level personnel) to access summarized information regarding one or more projects. This information may be provided as an overview of a project or as detailed information regarding user-specified criteria. The dashboard module also typically enables users to generate reports (e.g., based upon report templates or user-identified criteria).

The dashboard module 13 typically has administrative functionality. In this regard, users may use the dashboard module to enter information regarding companies (e.g., contractors and subcontracts) working on a project, including information regarding employees (e.g., workers) of each company (e.g., employee roles and security level). In this regard, companies using the purchasing system typically have to include information relating to an account (e.g., a credit card account, bank account, or PayPal™ account) for the transfer of funds to the purchasing system. Furthermore, the purchasing system typically performs a credit check for companies using the purchasing system. Users may also use the dashboard module to set up new projects (e.g., construction projects), such as by assigning companies and employees to work on a particular project. Users will also be able to assign companies and employees to existing projects. In one embodiment, new materials, workers, and tasks added by a user of the field-application module may have to be validated by a user (e.g., an administrator) through the dashboard module.

Access to the dashboard module, particularly its administrative functionality, may be limited to users with proper security levels (e.g., administrative access). For example, the purchasing system may have three different security levels, namely administrator, supervisor, and worker. The security level of users may permit or not permit them to access other features of the purchasing system. When a user accesses the purchasing system (e.g., by logging in through a data-entry device), the purchasing system will typically check level of security access provided to that user.

Access to the dashboard module 13 is typically achieved with a device (e.g., a cellular telephone or a personal computer) connected to the purchasing system 10 over a network. To facilitate use of the dashboard module 13, the purchasing system 10 may provide the user device with a graphical user interface (GUI).

The vendor module 14 enables vendors to bid to provide materials, labor, and/or services for a project. In this regard, users (e.g., vendors) of the vendor module are typically able (i) to view bid requests, including the time remaining to place a bid, received by the purchasing module, (ii) to place bids, (iii) to check the status of bids (e.g., whether a bid is pending, accepted, or not accepted), (iv) to view the purchase order related to an accepted bid, and (v) to view tracking information (e.g., delivery status) related to a purchase order. In addition, the vendor module typically enables users to view their bid and order history.

In this regard, once the purchasing module receives a bid request from a user, the vendor module will transmit (e.g., automatically transmit) the bid request to the relevant vendors, namely those vendors on the vendor list stored in the cloud database who have identified themselves as wanting to receive bid requests for the type of materials, labor, and/or services requested. After the vendor module receives bids (e.g., including pricing, delivery times, and quantity restrictions) from one or more vendors, the purchasing module transmits the bids to the user. Once the user transmits a purchase order to the purchasing module (e.g., by pressing an “accept bid” button in a GUI), the vendor module transmits the purchase order to the relevant vendor. In addition, the vendor module typically transmits a notification to vendors whose bids were not accepted. This notification may include the price of the accepted bid. Once the purchasing module receives a delivery confirmation from the user, the purchasing system will typically transmit this delivery confirmation to the relevant vendor and transfer the funds related to the purchase order to the relevant vendor.

In one embodiment, the purchasing system includes a filtering module for filtering the bids received by the vendor module to create a subset of bids to send to the user via the purchasing module within the field-application module. In this regard, the filtering module typically includes an algorithm for filtering the bids. The algorithm may employ artificial intelligence to compare prices, surcharges, delivery times, minimum quantities, prior successful deliveries, or any other vendor information that is useful in selecting a vendor. By way of example, the filtering module may filter the received bids by price and select a limited number (e.g., three) of the lowest priced bids to send to the user. If the filtering module is used to create a subset of bids, when the vendor module transmits a notification to vendors whose bids were not accepted, this notification may include the price of each of the bids in the subset.

The vendor module allows vendors to add themselves to the vendor list that receives bids. In this regard, vendors can use the vendor module to add to or edit their information. For example, vendors can typically use the vendor module to edit the type of materials, labor, and/or services for which they will receive bid requests.

In a particular embodiment, the purchasing system 10 includes a data-analysis module in communication with the cloud database 11. Typically, the data-analysis module analyzes the information within the cloud database (e.g., information collected by the purchasing system). More typically, the data-analysis module analyzes pricing and availability information for labor and/or materials that has populated the cloud database. The information within the cloud database is typically populated by information collected by the purchasing system as vendors respond to bid requests. In this regard, as more users purchase labor and materials from vendors the purchasing system has incrementally more access to vendor information regarding pricing and availability. Alternatively, the cloud database may be populated with some information (e.g., pricing information) obtained outside the normal operation of the purchasing system.

The data-analysis module typically analyzes this information to determine the current pricing (e.g., the average price) of particular materials, labor, and/or services (e.g., in real time). The data-analysis module also typically analyzes this information to detect pricing trends over time (e.g., by creating a trend line) in order to predict the future costs of particular materials and labor.

Information analyzed by the data-analysis module may be accessible to users through the field-application module and to vendors through the vendor module. This information can be used by vendors to determine how much to bid and by users to determine whether a bid should be accepted. Access to this information may be provided to third parties (i.e., entities that are not users or vendors) in communication with the purchasing system. In one embodiment, access to the information analyzed by the data-analysis module, such as current pricing and predicted future pricing of particular materials, labor, and/or services, may be limited to users, vendors, and third parties that have paid a subscription fee.

Because the data-analysis module can be used to predict future costs, users and vendors employing the present purchasing system may enter into futures contracts (i.e., contracts with delivery and payment occurring at a specified future date) for materials, labor, and/or services (e.g., at the predicted future cost). Accordingly, bid requests, bids, and purchase orders received by the present purchasing system may specify that delivery and payment occur at a specified future date. It is within the ambit of this system to provide these contracts on a liquidated market that allows for buying, selling, and trading the construction contracts as a commodity.

Although the present invention has been described with respect to the purchase of labor and materials for use on a construction site, the present invention is applicable to any number of other industries, particularly those industries that utilize procurement systems in the age-old manner of paper reports and layers of administration that could be minimized with the technology described herein.

In the specification and/or figure, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A system for managing labor and materials on a construction site, the system comprising:
a non-transitory computer-readable storage medium;
a processor for manipulating said computer-readable storage medium;
a database being stored on said computer-readable storage medium;
a field-application module for receiving information relating to materials, labor, and/or services on a construction site from a portable data-entry device, said field-application module being in communication with said database, and said field-application module storing said information relating to materials, labor, and/or services in said database; and
a vendor module for receiving vendor information, said vendor module being in communication with said database, and said vendor module storing said vendor information in said database;
wherein, in response to a bid request for materials, labor, and/or services received by said field-application module from the portable data-entry device, said vendor module transmits the bid request to a plurality of vendors in communication with said vendor module;
wherein, in response to one or more bids for materials, labor, and/or services received by said vendor module from one or more vendors, said field-application module transmits one or more of said bids to the portable data-entry device; and
wherein, in response to a purchase order for materials, labor, and/or services received by said field-application module from the portable data-entry device, said vendor module transmits said purchase order to the relevant vendor.

2. A system according to claim 1, wherein the information relating to materials, labor, and/or services comprises information regarding the presence and/or absence of labor and/or materials on a construction site.

3. A system according to claim 1, wherein the portable data-entry device is positioned at a construction site.

4. A system according to claim 3, wherein the portable data-entry device is positioned at a point of use on the construction site.

5. A system according to claim 1, wherein the portable data-entry device is a cellular telephone.

6. A system according to claim 1, wherein said vendor information comprises vendor pricing information.

7. A system according to claim 1, wherein, in response to bids for materials, labor, and/or services received by said vendor module from one or more vendors, said field-application module transmits a subset of said bids to the portable data-entry device.

8. A system according to claim 7, comprising a filtering module for filtering bids for materials, labor, and/or services received by said vendor module to create a subset of said bids.

9. A system according to claim 1, wherein said vendor module accepts bids for materials, labor, and/or services received from one or more vendors for a limited period of time.

10. A system according to claim 1, comprising:
a data-analysis module for analyzing pricing data stored on said database, said data-analysis module being in communication with said database, said database being populated with pricing information for materials, labor, and/or services;
wherein said data-analysis module analyzes the pricing data stored on said database to determine the current average price of a particular type of material, labor, or service.

11. A system according to claim 10, wherein access to the current average price of a particular type of material, labor, or service is provided (i) to a user of the portable data-entry device through said field-application module and/or (ii) to a vendor through said vendor module.

12. A system according to claim 11, wherein access to the current average price of a particular type of material, labor, or service is provided to users and/or vendors that have paid a subscription fee.

13. A system according to claim 10, wherein said data-analysis module analyzes the pricing data stored on said database to detect pricing trends for a particular type of material, labor, or service and predict the future cost of the particular type of material, labor, or service.

14. A system according to claim 13, wherein access to the predicted future cost of the particular type of material, labor, or service is provided (i) to a user of the portable data-entry device through said field-application module and/or (ii) to a vendor through said vendor module.

15. A system according to claim 14, wherein access to the predicted future cost of the particular type of material, labor, or service is provided to users and/or vendors that have paid a subscription fee.

16. A method of facilitating the purchase of materials, labor, and services, the method comprising:
providing a non-transitory computer-readable storage medium and a processor for manipulating the computer-readable storage medium, wherein a database in communication with a field-application module and a vendor module is stored on the computer readable-storage medium;
receiving a bid request for materials, labor, and/or services at the field-application module from a portable data-entry device, and, thereafter, transmitting the bid request with the vendor module to a plurality of vendors;
receiving one or more bids for materials, labor, and/or services at the vendor module from one or more vendors, and, thereafter, transmitting one or more of the bids with the field-application module to the portable data-entry device; and
receiving a purchase order for materials, labor, and/or services at the field-application module from the portable data-entry device, and, thereafter, transmitting the purchase order with the vendor module to the relevant vendor.

17. A method according to claim 16, wherein the portable data-entry device is positioned at a point of use on a construction site.

18. A method according to claim 16, wherein, the step of transmitting one or more of the bids with the field-application module to the portable data-entry device comprises transmitting a subset of the bids to the portable data-entry device.

19. A method according to claim 16, comprising:
populating the database with pricing information for materials, labor, and/or services; and
analyzing the pricing data to determine the current average price of a particular type of material, labor, and/or service with a data-analysis module in communication with the database.

20. A method according to claim 19, comprising providing access to the current average price of a particular type of material, labor, and/or service (i) to a user of the portable data-entry device through the field-application module, the user having paid a subscription fee, and/or (ii) to a vendor through the vendor module, the vendor having paid a subscription fee.

21. A method according to claim 19, comprising analyzing the pricing data to detect pricing trends for a particular type of material, labor, and/or service and predict the future cost of the particular type of material, labor, and/or service.

22. A method according to claim 21, comprising providing access to the predicted future cost of a particular type of material, labor, and/or service (i) to a user of the portable data-entry device through the field-application module, the user having paid a subscription fee, and/or (ii) to a vendor through the vendor module, the vendor having paid a subscription fee.

23. A method according to claim 21, wherein the step of receiving a purchase order comprises receiving a purchase order, wherein the delivery and payment specified in the purchase order occur at a specified future date.

24. A method according to claim 16, wherein the step of receiving a bid request comprises receiving a bid request, wherein the delivery and payment specified in the bid request occur at a specified future date.

25. A method according to claim 24, wherein:
the step of receiving one or more bids comprises receiving a bid, wherein the delivery and payment specified in the bid occur at a specified future date; and
the step of receiving a purchase order comprises receiving a purchase order, wherein the delivery and payment specified in the purchase order occur at a specified future date.
